(19) United States
(12) Patent Application Publication
(10) Pub. No.: US 2009/0059020 A1
(43) Pub. Date: Mar. 5, 2009

(54) DATA PROCESSING CIRCUIT, SEMICONDUCTOR DEVICE, CAMERA DEVICE AND METHOD FOR CONTROLLING DATA PROCESSOR

(76) Inventor: Kunihiro IMAMURA, Osaka (JP)

Correspondence Address: MCDERMOTT WILL & EMERY LLP, 600 13TH STREET, NW, WASHINGTON, DC, 20005-3096, US

(21) Appl. No.: 12/199,953

(22) Filed: Aug. 28, 2008

(30) Foreign Application Priority Data
Sep. 5, 2007 (JP) 2007-230018

(51) Int. Cl. H04N 5/225

(52) U.S. Cl. 348/220.1; 348/E05.024

(57) ABSTRACT

A storing part stores contents data to be reproduced in switching an operational mode. A reproducing part reproduces data to be reproduced in each of a plurality of operational modes and the contents data stored in the storing part. A controlling part allows, in detecting operational mode switching, the reproducing part to reproduce the contents data until a contents reproducing time necessary for reproducing the contents data elapses, and allows the reproducing part to reproduce given data to be reproduced in the switched operational mode after the contents reproducing time has elapsed.

### CROSS-REFERENCE TO RELATED APPLICATIONS

This application claims priority under 35 U.S.C. §119 on Patent Application No. 2007-230018 filed in Japan on Sep. 5, 2007, the entire contents of which are hereby incorporated by reference.

### BACKGROUND OF THE INVENTION

The present invention relates to a data processing circuit, a semiconductor device and a camera device capable of switching selectively among a plurality of operational modes, and more particularly, it relates to a technique to reproduce an arbitrary image or arbitrary sound in operational mode switching.

In electronic equipment such as a digital camera, it is necessary to execute a variety of processing (such as initialization or modification of setting) for switching an operational mode, and hence, there unavoidably arises a waiting time before attaining an operable state in operational mode switching. Therefore, a user is under stress because processing cannot be rapidly proceeded.

In order to cope with this problem, a digital camera having a function to display an arbitrary image at the time of power application is recently available. In a digital camera having such a function, image data is previously stored in a memory included in the digital camera, so that the image data can be reproduced every time the power is applied for displaying an arbitrary image on a display screen until the digital camera is activated (namely, is placed in an operable state). When an arbitrary image is displayed in this manner, the waiting time necessary for the starting can be spent without stress.

Furthermore, in order to reduce the stress derived from the waiting time caused in the power application, a technique to shorten the waiting time caused at the starting by increasing the starting speed of a digital camera is known. For example, in Japanese Laid-Open Patent Publication No. 2002-237977, a technique to shorten the starting time of a camera by reading previously stored camera conditions at the starting time is disclosed.

In the conventional technique, however, the image is deleted from the display screen immediately after completing the operational mode switching. Therefore, although the waiting time can be shortened by increasing the speed of the operational mode switching, the time when the image is displayed on the display screen is also shortened. In this manner, as compared with the cost spent on the function addition, it is difficult to sufficiently provide a user the effect to reduce the stress through the image display (the effect to reduce the stress derived from the waiting time). For example, in the case where the time when the image is displayed is very short, the image is deleted before a user visually recognizes the image.

### SUMMARY OF THE INVENTION

Therefore, an object of the invention is improving the stress reducing effect as compared with that of the conventional technique by securing a time necessary for reproducing contents of an image or a sound in the operational mode switching.

According to one aspect of the invention, the data processing circuit capable of switching selectively among a plurality of operational modes includes a storing part for storing contents data to be reproduced in operational mode switching; a reproducing part for reproducing data to be reproduced in each of the plurality of operational modes and reproducing the contents data stored in the storing part; and a controlling part for allowing, in detecting the operational mode switching, the reproducing part to reproduce the contents data until a contents reproducing time necessary for reproducing the contents data elapses and allowing the reproducing part to reproduce given data to be reproduced in a switched operational mode after the contents reproducing time elapses.

Since the reproducing time for the contents data is secured in this data processing circuit, the contents data can be appropriately reproduced in the operational mode switching. For example, the contents data reproducing time can be set to be sufficiently long for a user to visually or aurally recognize a content included in the contents data (such as an image or a sound). Therefore, the effect to reduce stress by reproducing the contents data can be improved as compared with that of the conventional technique.

The contents reproducing time is preferably longer than a time necessary for completing the operational mode switching. Also, the controlling part preferably elongates the contents reproducing time when the contents reproducing time is shorter than the time necessary for completing the operational mode switching. Thus, the content can be reproduced for a longer duration than in the conventional technique, and hence, the effect to reduce the stress can be improved as compared with that of the conventional technique.

Furthermore, the data processing circuit may further include a setting part for setting the contents reproducing time on the basis of a data size (such as a file size, a code size, a code size to be reproduced per unit time or a view angle size) of the contents data stored in the storing part, complexity of the contents data, a residue of a power source for supplying power to the data processing circuit, or a reproducing time included in a header of the contents data.

Moreover, the contents reproducing time may be externally settable.

According to another aspect of the invention, the semiconductor device capable of switching selectively among a plurality of operational modes includes a storing part for storing contents data to be reproduced in operational mode switching; a reproducing part for reproducing data to be reproduced in each of the plurality of operational modes and reproducing the contents data stored in the storing part; and a controlling part for allowing, in detecting the operational mode switching, the reproducing part to reproduce the contents data until a contents reproducing time necessary for reproducing the contents data elapses and allowing the reproducing part to reproduce given data to be reproduced in a switched operational mode after the contents reproducing time elapses.

Since the contents data reproducing time is secured in this semiconductor device, the effect to reduce the stress by reproducing the contents data can be improved as compared with that of the conventional technique.

According to still another aspect of the invention, the camera device capable of switching selectively among a plurality of operational modes including a camera mode includes an image processing unit for converting an image of a subject into an electric signal and generating image data on the basis of the electric signal in the camera mode; a storing part for storing contents data to be reproduced in switching to the camera mode; and a data processing part for reproducing, in detecting the switching to the camera mode, the contents data until a contents reproducing time necessary for reproducing the contents data elapses and for reproducing image data obtained by the image processing unit after the contents reproducing time elapses.

Since the contents data reproducing time is secured in this camera device, the effect to reduce the stress by reproducing the contents data can be improved as compared with that of the conventional technique.

According to still another aspect of the invention, the method for controlling a data processor having a plurality of operational modes includes the steps of (a) switching an operational mode of the data processor; (b) allowing the data processor to reproduce previously determined contents data after switching the operational mode in the step (a) and to continuously reproduce the contents data until a contents reproducing time necessary for reproducing the contents data elapses; and (c) allowing the data processor to reproduce data to be reproduced in the switched operational mode after the contents reproducing time elapses.

Since the contents data reproducing time is secured in this method for controlling a data processor, the effect to reduce the stress by reproducing the contents data can be improved as compared with that of the conventional technique.

### BRIEF DESCRIPTION OF THE DRAWINGS

FIG. 1 is a block diagram for showing the architecture of a camera device according to Embodiment 1 of the invention.

FIG. 2 is a block diagram for showing the internal configuration of a digital signal processing circuit of FIG. 1.

FIG. 3 is a diagram for explaining the operation of the digital signal processing circuit of FIG. 2.

FIG. 4 is a block diagram for showing the internal configuration of a digital signal processing circuit according to Embodiment 2 of the invention.

FIG. 5 is a diagram for explaining the operation of the digital signal processing circuit of FIG. 4.

FIG. 6 is a block diagram for showing the internal configuration of a digital signal processing circuit according to Embodiment 3 of the invention.

FIG. 7 is a diagram for explaining the operation of the digital signal processing circuit of FIG. 6.

FIG. 8 is a block diagram for showing the internal configuration of a digital signal processing circuit according to Embodiment 4 of the invention.

FIG. 9 is a block diagram of a modification of the digital signal processing circuit.

FIG. 10 is a diagram for explaining an operation of the digital signal processing circuit of FIG. 9.

FIG. 11 is a diagram for explaining another operation of the digital signal processing circuit of FIG. 9.

FIG. 12 is a block diagram of another modification of the digital signal processing circuit.

### DETAILED DESCRIPTION OF THE INVENTION

Preferred embodiments of the invention will now be described with reference to the accompanying drawings. It is noted that like reference numerals are used to refer to like elements in the drawings so as to avoid repeating description.

### Embodiment 1

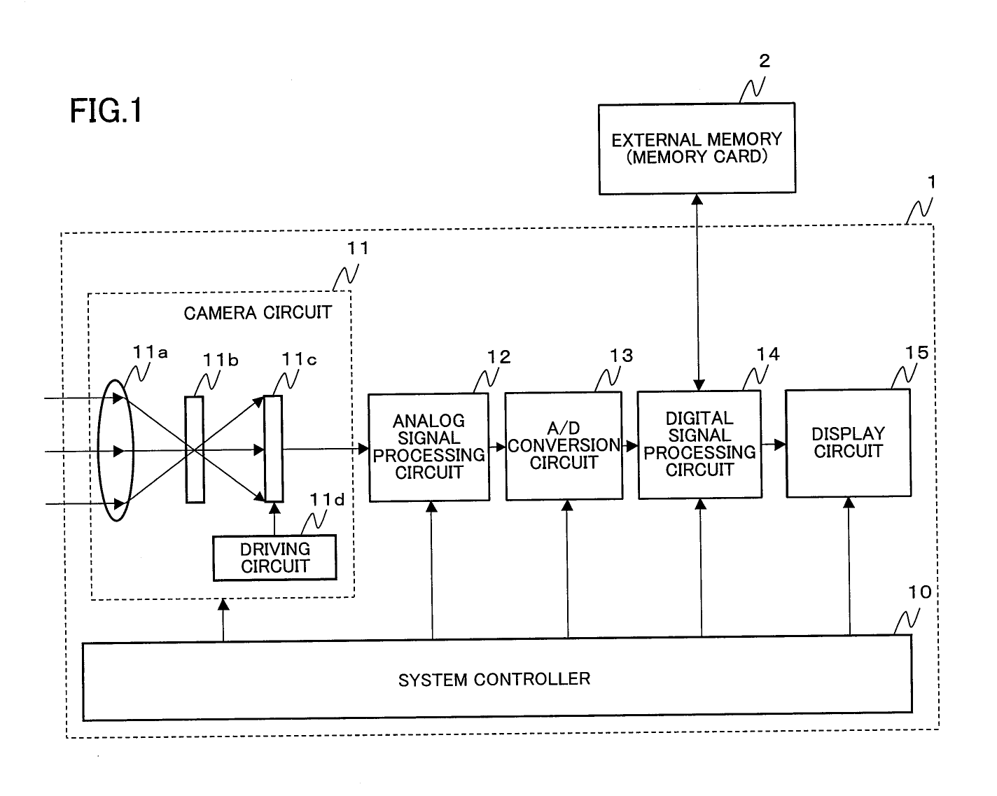

FIG. 1 shows the architecture of a camera device 1 according to Embodiment 1 of the invention. The camera device 1 selectively executes a plurality of operational modes such as a camera mode in which a subject is monitored to be shot and a preview mode in which an image stored in an external memory 2 (such as a memory card) is reproduced. Furthermore, in the camera device 1, a previously set content (such as an image or a sound) is reproduced in operational mode switching. The external memory 2 stores contents data corresponding to such a content (which is herein assumed to be static image data).

The camera device 1 includes a system controller 10, an imaging circuit 11, an analog signal processing circuit 12, an A/D conversion circuit 13, a digital signal processing circuit 14 (a data processing circuit) and a display circuit 15.

The imaging circuit 11 is a circuit for taking a photograph of a subject and generating an analog image signal and is composed of, for example, an optical lens 11a, an IR cut filter 11b, an image sensor 11c and a driving circuit 11d. The optical lens 11a forms an image of incident light from the subject on the image sensor 11c. The IR cut filter 11b removes a long wavelength component of light entering the image sensor 11c. The image sensor 11c is what is called a single-plate type CCD (charge coupled device) image sensor, and each of photoelectric conversion elements two-dimensionally arranged therein is provided with a color filter for filtering incident light. The image sensor 11c reads charge in accordance with a driving signal supplied by the driving circuit 11d and outputs an analog image signal.

The analog signal processing circuit 12 performs processing such as correlated double sampling or signal amplification on the analog image signal output from the imaging circuit 11.

The A/D conversion circuit 13 converts the analog image signal having been processed by the analog signal processing circuit 12 into digital image data.

The digital signal processing circuit 14 performs digital processing on the digital image data supplied from the A/D conversion circuit 13 and writes the processed digital image data in the external memory 2. Also, the digital signal processing circuit 14 reproduces the processed digital image data or digital image data stored in the external memory 2 (for example, decodes digital image data).

The display circuit 15 receives the digital image data reproduced by the digital signal processing circuit 14 to be displayed.

The system controller 10 selects an operational mode in accordance with an instruction given by a user and controls the respective components of the camera device 1 on the basis of the selected operational mode. For example, when the “camera mode” is selected by the system control 10, the imaging circuit 11, the analog signal processing circuit 12 and the A/D conversion circuit 13 are placed in an operable state after executing preparation for taking a photograph (such as initialization). Alternatively, when the “preview mode” is selected by the system controller 10, the digital signal processing circuit 14 is placed in a preview reproducing state after executing preparation for preview display.

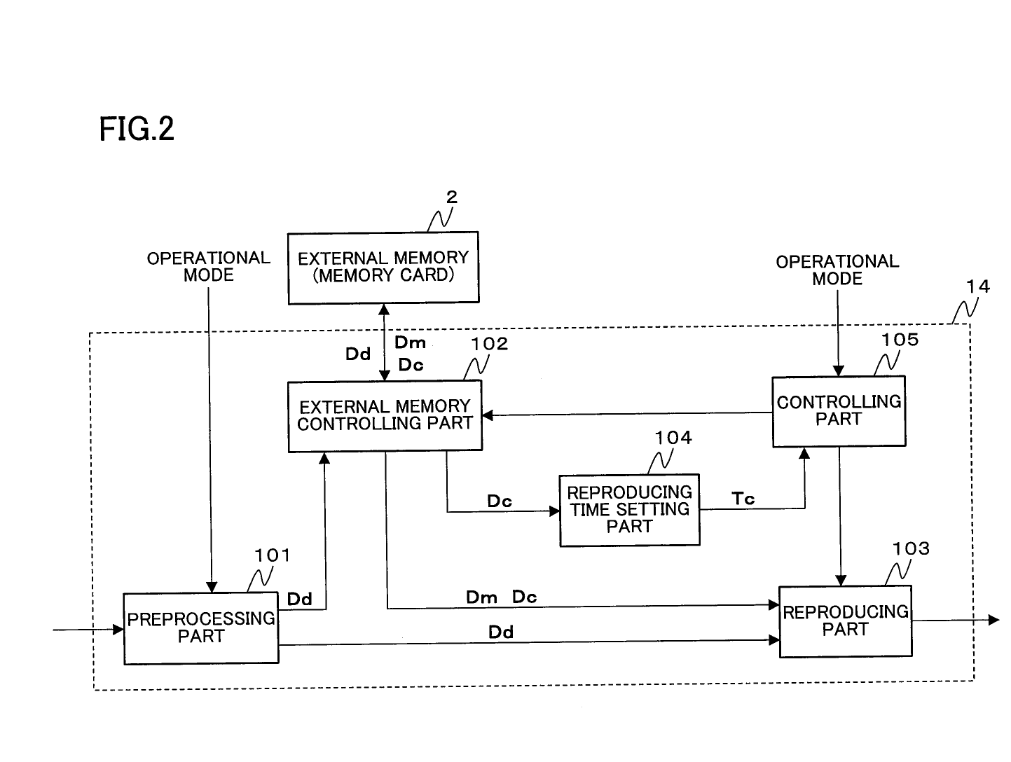

FIG. 2 shows the configuration of the digital signal processing circuit 14 shown in FIG. 1. The digital signal processing circuit 14 includes a preprocessing part 101, an external memory controlling part 102, a reproducing part 103, a reproducing time setting part 104 and a controlling part 105.

The preprocessing part 101 executes preprocessing such as YC processing on the digital image data supplied from the A/D conversion circuit 13.

The external memory controlling part 102 writes the digital image data Dd having been processed by the preprocessing part 101 in the external memory 2 (a memory card). Also, the external memory controlling part 102 reads digital image data Dm or contents data Dc from the external memory 2.

The reproducing part 103 reproduces the digital image data Dd having been processed by the preprocessing part 101 and the digital image data Dm and the contents data Dc read by the external memory controlling part 102 from the external memory 2.

The reproducing time setting part 104 sets a time necessary for reproducing the contents data Dc (i.e., a contents reproducing time Tc) on the basis of a data size (such as a file size, a code size, a code size to be processed per unit time by the reproducing part 103 or a view angle size) of the contents data Dc stored in the external memory 2. For example, the reproducing time setting part 104 sets the contents reproducing time Tc longer as the data size of the contents data Dc is larger.

The controlling part 105 controls the external memory controlling part 102 and the reproducing part 103 in response to the control by the system controller 10. Also, the controlling part 105 controls the external memory controlling part 102 so as to supply the contents data Dc stored in the external memory 2 to the reproducing time setting part 104 for allowing the reproducing time setting part 104 to set the contents reproducing time Tc. Furthermore, the controlling part 105 detects the operational mode switching by monitoring the selection of the operational modes by the system controller 10 (namely, which operational mode is selected by the system controller 10).

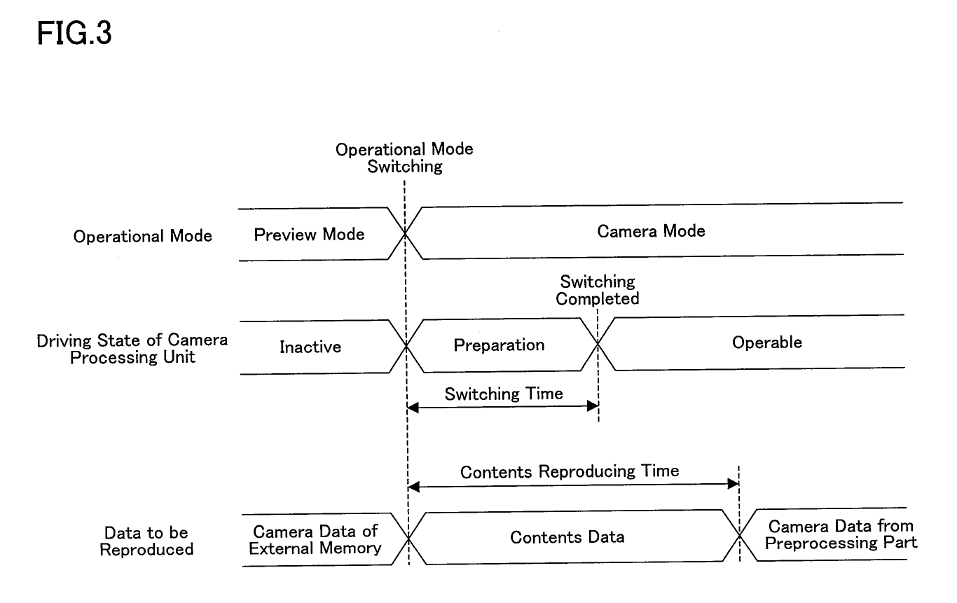

Next, the operation of the camera device 1 of FIG. 1 will be described with reference to FIG. 3. In the following description, it is assumed that the “preview mode” is switched to the “camera mode”.

First, the system controller 10 has selected the “preview mode”. At this point, the imaging circuit 11, the analog signal processing circuit 12, the A/D conversion circuit 13 and the preprocessing part 101 of the digital signal processing circuit 14 (which are hereinafter together referred to as an image processing unit) are in an inactive state. Also, in the digital signal processing circuit 14, the external memory controlling part 102 reads digital image data Dm (namely, data to be reproduced in the preview mode) from the external memory 2 to supply it to the reproducing part 103, and the reproducing part 103 reproduces the digital image data Dm to be supplied to the display circuit 15. Thus, the digital image data Dm stored in the external memory 2 is displayed by the display circuit 15 as an image.

Next, the system controller 10 switches the operational mode from the “preview mode” to the “camera mode”. In response to the control by the system controller 10, the image processing unit starts preparation for taking a photograph of a subject. Also, in the digital signal processing circuit 14, the controlling part 105 detects the operational mode switching and controls the external memory controlling part 102 and the reproducing part 103. The external memory controlling part 102 reads contents data Dc from the external memory 2 in response to the control by the controlling part 105, and the reproducing part 103 reproduces the contents data Dc supplied from the external memory controlling part 102 in response to the control by the controlling part 105. Thus, the contents data Dc is displayed by the display circuit 15 as an image. Furthermore, the controlling part 105 starts counting time when it detects the operational mode switching.

Next, the image processing unit completes the preparation for taking a photograph and enters an “operable state”. In other words, the operational mode switching is completed. Then, when the time having elapsed after detecting the operational mode switching becomes equal to a contents reproducing time Tc, the controlling part 105 allows the reproducing part 103 to reproduce digital image data Dd (namely, data to be reproduced in the camera mode) supplied from the preprocessing part 101. Thus, the photograph of the subject taken by the imaging circuit 11 is displayed by the display circuit 15 as an image.

In this manner, the contents data Dc is displayed as an image until the contents reproducing time Tc elapses after the operational mode switching, and the photograph of the subject taken by the imaging circuit 11 is displayed as an image after the contents reproducing time Tc has elapsed.

A similar operation is performed also when the “camera mode” is switched to the “preview mode” or when power is applied to the camera device 1. For example, when the power is applied (namely, the power supply is turned on), the system controller 10 selects an initial mode (such as the camera mode). Thus, the image processing unit starts the preparation for taking a photograph and the controlling part 105 of the digital signal processing circuit 14 executes the aforementioned processing.

Thus, a time necessary for reproducing the contents data can be secured, and the contents data can be appropriately reproduced in the operational mode switching. For example, the contents reproducing time Tc can be set to a sufficient duration in which a content corresponding to the contents data Dc can be visually recognized by a user. In this manner, an effect to reduce stress by reproducing a content can be improved as compared with that of the conventional technique.

It is noted that the contents reproducing time Tc can be set on the basis of the complexity (such as a ratio of a high frequency component) of the contents data instead of the data size of the contents data. For example, the reproducing time setting part 104 sets the contents reproducing time Tc longer as the complexity of the contents data is higher. Alternatively, the contents reproducing time Tc may be set on the basis of a residue of the power supplied to the camera device 1. For example, the reproducing time setting part 104 sets the contents reproducing time Tc longer as the residue of the power is larger. Alternatively, in the case where the operational frequency is lowered for suppressing the power consumption, the reproducing time setting part 104 sets the contents reproducing time Tc longer as the residue of the power is smaller. Furthermore, in the case where the contents data has a header including a reproducing time for the contents data, the reproducing time setting part 104 may set the contents reproducing time Tc on the basis of the reproducing time included in the header.

Moreover, the external memory 2 may store a plurality of contents data. In this case, when the operational mode switching is detected, the controlling part 105 controls the external memory controlling part 102 so as to supply one of the plural contents data to the reproducing part 103. At this point, the reproducing time setting part 104 may calculate a reproducing time necessary for each of the contents data so as to set the longest reproducing time among the calculated reproducing times as the contents reproducing time Tc. Thus, all the contents data can be appropriately reproduced. Alternatively, the shortest reproducing time among the calculated reproducing times may be set as the contents reproducing time Tc. Thus, a time elapsing until the execution of a switched operational mode can be shortened. Alternatively, the reproducing time setting part 104 may execute weighted addition of the calculated plural reproducing times so as to set the resultant as the contents reproducing time Tc.

It is noted that the contents reproducing time Tc is preferably longer than a time necessary for completing the operational mode switching (namely, a switching time). In the conventional technique, a content is deleted immediately after completing the operational mode switching, but when the contents reproducing time Tc is longer than the switching time, the content can be reproduced for a longer duration than in the conventional technique. Thus, the effect to reduce the stress by reproducing a content can be improved as compared with that of the conventional technique. In the case where there is a fear of the contents reproducing time Tc shorter than the switching time, the camera device is preferably controlled as described in an embodiment described below.

### Embodiment 2

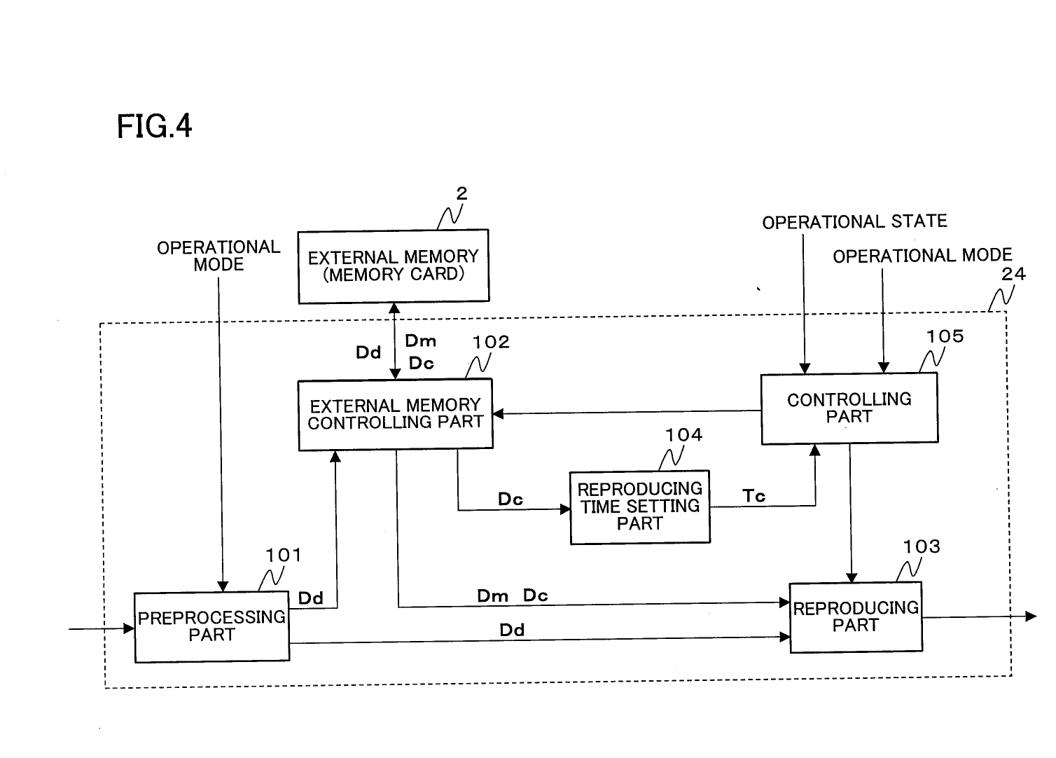

A camera device 1 according to Embodiment 2 of the invention includes a digital signal processing circuit 24 shown in FIG. 4 instead of the digital signal processing circuit 14 shown in FIGS. 1 and 2. The digital signal processing circuit 24 has the same configuration as that shown in FIG. 2 but is different in the processing performed by a controlling part 105. The controlling part 105 of this embodiment monitors the operational states of respective components of the camera device 1 (such as an imaging circuit 11, an analog signal processing circuit 12 and an A/D conversion circuit 13). Also, in the case where a contents reproducing time Tc is shorter than a time necessary for completing operational mode switching (namely, a switching time), the controlling part 105 elongates the contents reproducing time Tc. The rest of the configuration of the digital signal processing circuit 24 is the same as that shown in FIG. 2.

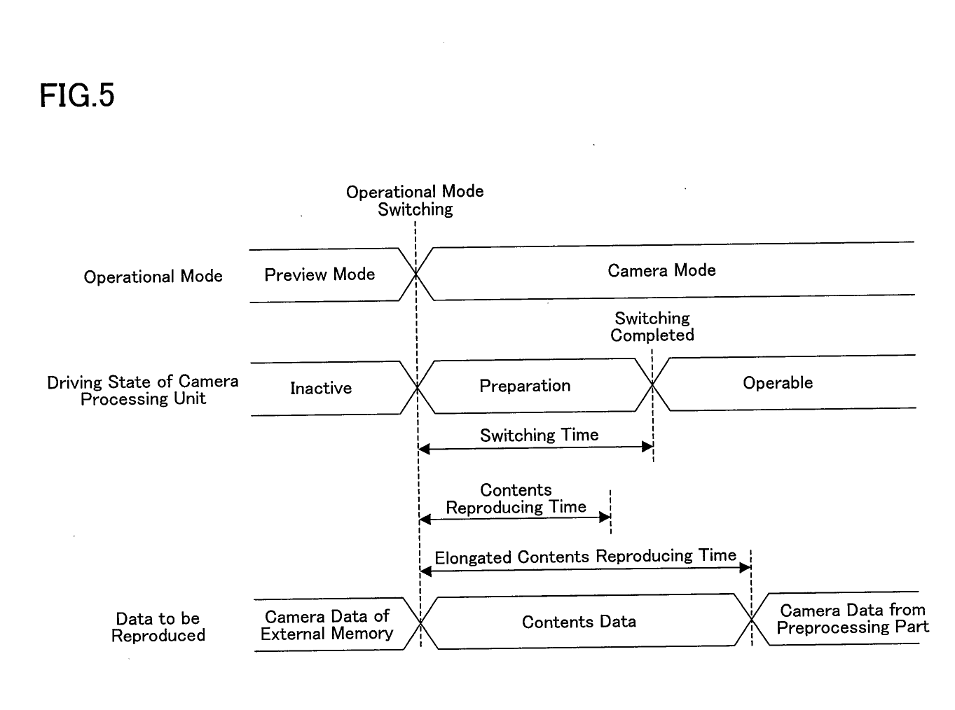

Next, the operation of the digital signal processing circuit 24 of FIG. 4 will be described with reference to FIG. 5. It is noted that the operation of the digital signal processing circuit 24 is the same as that described with reference to FIG. 3 except for the processing for elongating the contents reproducing time Tc.

When the operational mode is switched from the “preview mode” to the “camera mode” by a system controller 10, an image processing unit starts preparation for taking a photograph and contents data Dc is displayed by a display circuit 15 as an image.

Next, the controlling part 105 detects that the contents reproducing time Tc has elapsed. At this point, since the image processing unit is still in the “preparation state” (namely, the operational mode switching has not been completed), the controlling part 105 elongates the contents reproducing time Tc. Thus, the contents data Dc is continuously reproduced.

Then, the controlling part 105 detects that the elongated contents reproducing time has elapsed. At this point, since the image processing unit is in an “operable state” (namely, the operational mode switching has been completed), the controlling part 105 allows a reproducing part 103 to reproduce digital image data Dd supplied by a preprocessing part 101. Thus, a photograph of a subject taken by the imaging circuit 11 is displayed by the display circuit 15 as an image.

In this manner, since the contents reproducing time Tc is elongated to be longer than the time necessary for completing the operational mode switching (the switching time), the contents data can be reproduced for a longer period than in the conventional technique, and thus, the effect to reduce the stress can be improved.

### Embodiment 3

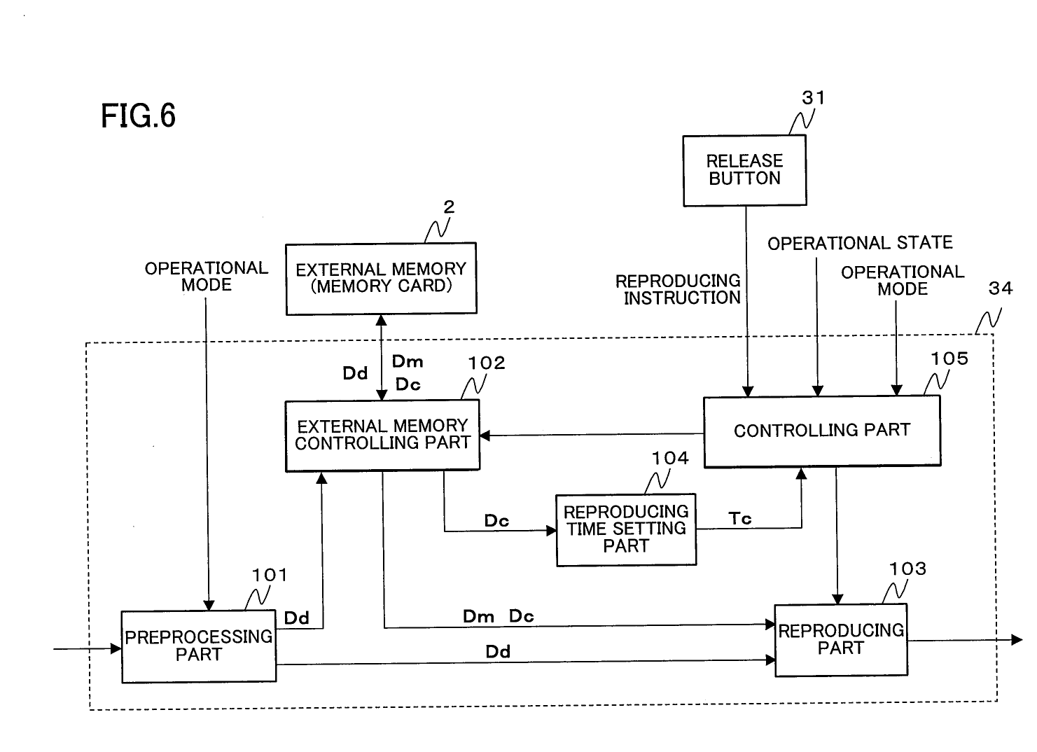

A camera device 1 according to Embodiment 3 of the invention includes, in addition to the components shown in FIG. 1, a release button 31 and includes, instead of the digital signal processing circuit 14 of FIGS. 1 and 2, a digital signal processing circuit 34 as shown in FIG. 6.

The digital signal processing circuit 34 has the same configuration as that shown in FIG. 2 and is different in the processing performed by a controlling part 105. The controlling part 105 of this embodiment monitors the operational states of respective components of the camera device 1. Also, when the release button 31 is pushed down by a user, the release button 31 transmits a reproducing instruction to the controlling part 105 of the digital signal processing circuit 34. If the reproducing instruction is transmitted when an image processing unit is in an “operable state” (namely, after completing the operational mode switching), the controlling part 105 allows a reproducing part 103 to reproduce digital image data Dd supplied by a preprocessing part 101 (namely, reproduction of contents data is suspended) even before a contents reproducing time Tc has elapsed.

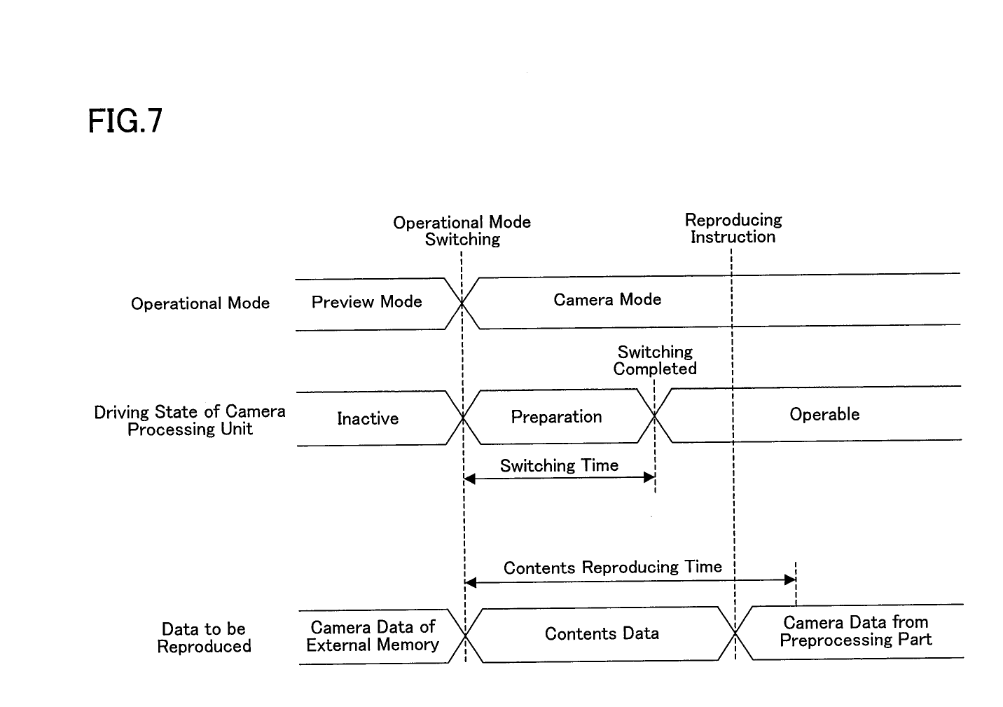

Next, the operation of the signal processing circuit 34 of FIG. 6 will be described with reference to FIG. 7. It is noted that the operation of the digital signal processing circuit 34 is the same as that shown in FIG. 3 except for the processing for suspending the reproduction of the contents data.

When the operational mode is switched from a “preview mode” to a “camera mode” by a system controller 10, the image processing unit starts preparation for taking a photograph and contents data Dc is displayed by a display circuit 15 as an image.

Next, the image processing unit completes the preparation for taking a photograph and enters an “operable state” (namely, the operational mode switching is completed). Then, before the contents reproducing time Tc elapses, the release button 31 is pushed down so as to transmit a reproducing instruction to the controlling part 105. At this point, since the controlling part 105 has detected the completion of the operational mode switching, it allows the reproducing part 103 to suspend the reproduction of the contents data Dc and to reproduce digital image data Dd supplied by the preprocessing part 101. Thus, a photograph of a subject taken by an imaging circuit 11 is displayed by the display circuit 15 as an image.

In this manner, even while the contents data is being reproduced, the reproduction of the contents data can be suspended in response to an instruction made by a user as far as the operational mode switching has been completed. Therefore, an unnecessary waiting time can be avoided.

It is noted that the processing for elongating the contents reproducing time (described with reference to FIG. 5) may be executed in the digital signal processing circuit 34 of FIG. 6.

### Embodiment 4

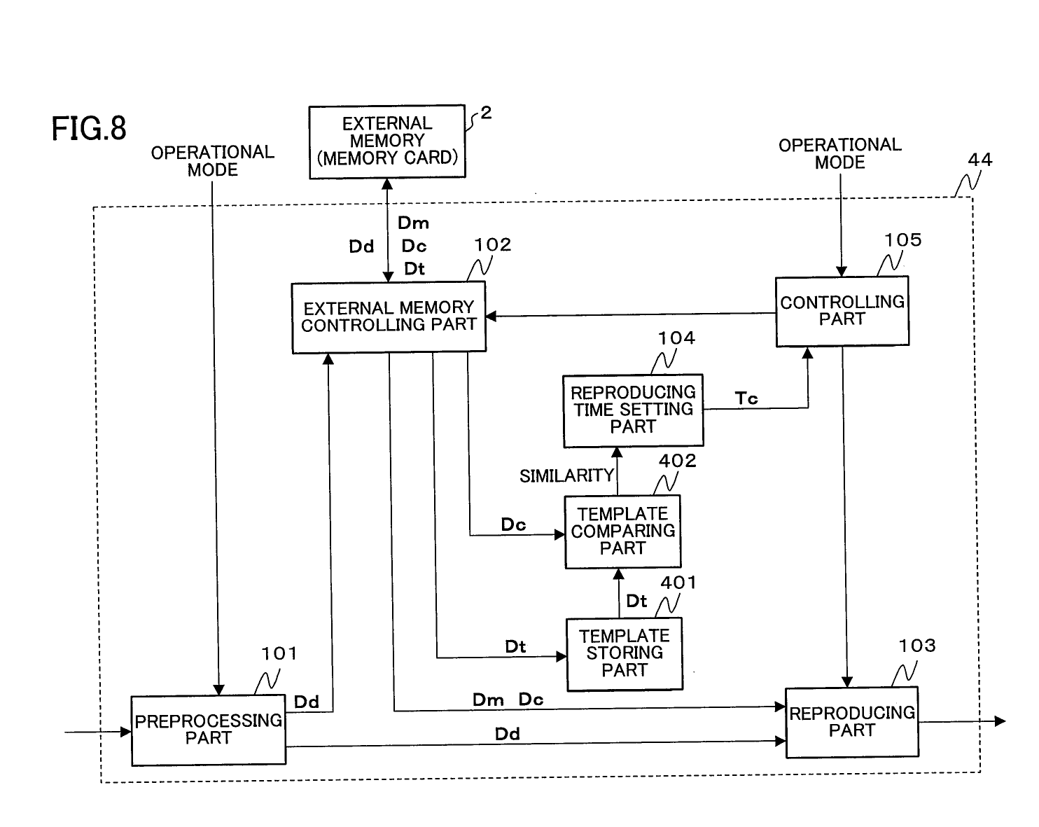

A camera device 1 according to Embodiment 4 of the invention includes, instead of the digital signal processing circuit 14 of FIGS. 1 and 2, a digital signal processing circuit 44 as shown in FIG. 8. Also, an external memory 2 stores not only digital image data and contents data but also template data. The template data is data set on the basis of tastes of a user and includes, for example, images or sounds particularly pleasing a user.

The digital signal processing circuit 44 includes, in addition to the components shown in FIG. 2, a template storing part 401 and a template comparing part 402. The template storing part 401 stores template data Dt read by an external memory controlling part 102 from the external memory 2. The template comparing part 402 obtains similarity between contents data Dc read by the external memory controlling part 102 from the external memory 2 and the template data Dt stored in the template storing part 401. For example, the template comparing part 402 detects a region of the contents data Dc according with a region of the template data Dt and sets similarity higher as the detected region is larger. A reproducing time setting part 104 sets a contents reproducing time Tc longer as the similarity obtained by the template comparing part 402 is higher.

For example, in the case where a face image (or a feature of a face) is included in the template data Dt, the template comparing part 402 detects a face image in the contents data Dc and sets the similarity higher as the number of detected face images is larger. Thus, in the case where a large number of face images is included in the contents data Dc as in a photograph of a group of people, the contents reproducing time Tc is set to be long, and hence, respective face images can be easily recognized.

Alternatively, in the case where a face image of an acquaintance is included in the template data Dt, the template comparing part 402 sets the similarity higher when the face image of the acquaintance is detected in the contents data Dc. Thus, the contents reproducing time Tc is set to be long when the face image of the acquaintance is included in the contents data Dc, and hence, a user can seek the face of the acquaintance without haste.

In this manner, in the case where a content pleasing a user is reproduced, the effect to reduce the stress can be further improved by setting the reproducing time for the content longer. It is noted that the template data Dt may include, apart from the face images, images of animals or other bodies.

Furthermore, the template storing part 401 and the template comparing part 402 may be included in any of the digital signal processing circuits 24 and 34 of FIGS. 4 and 6.

### Alternative Embodiments

### [Setting of Contents Reproducing Time]

Although the reproducing time setting part 104 sets the contents reproducing time Tc in each of the aforementioned embodiments, the contents reproducing time Tc may be externally set.

### [Kinds of Contents Data and Template Data]

The contents data Dc and the template data Dt are not limited to digital image data (static image data) but may be dynamic image data, speech data (music data or sound data), text data or the like. For example, the contents data Dc may be text data corresponding to instructions for taking photographs or the like.

### [Exemplified Configuration of Reproducing Part]

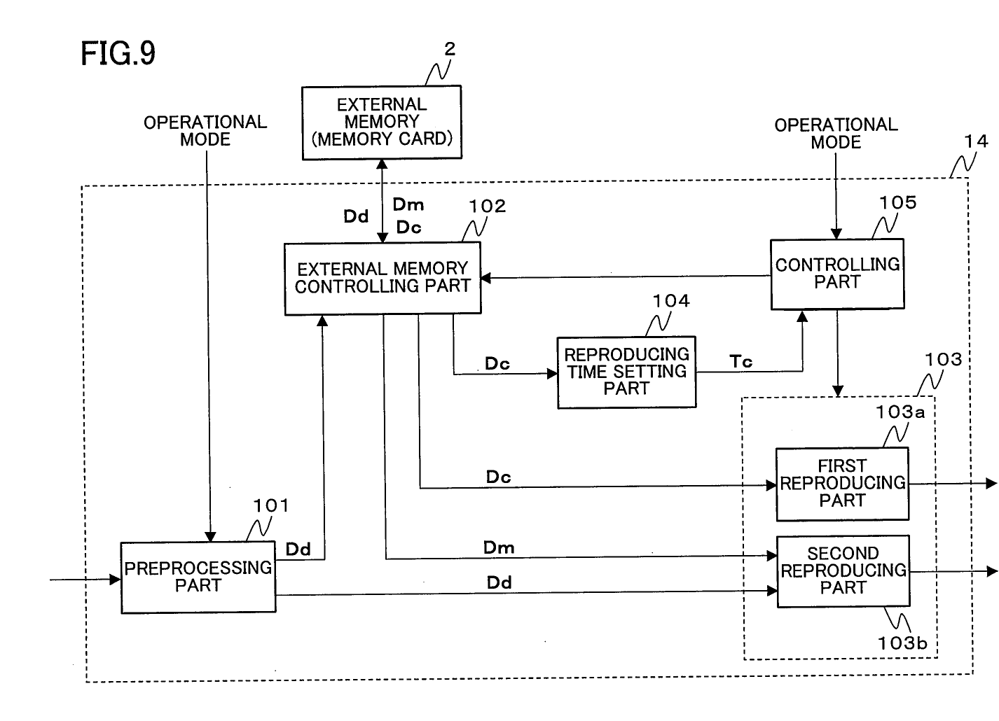

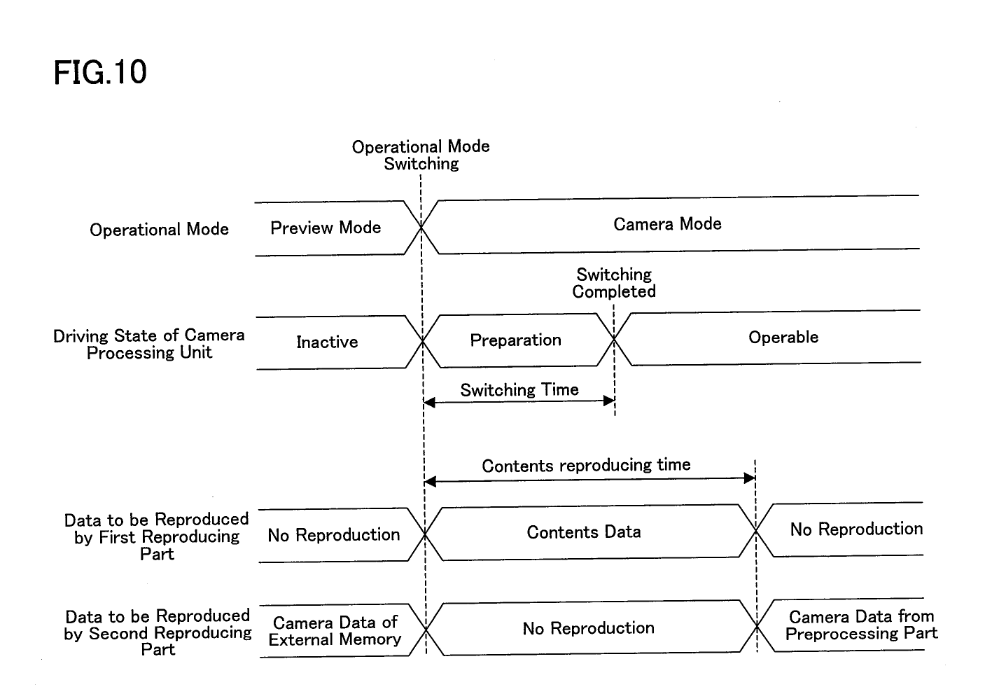

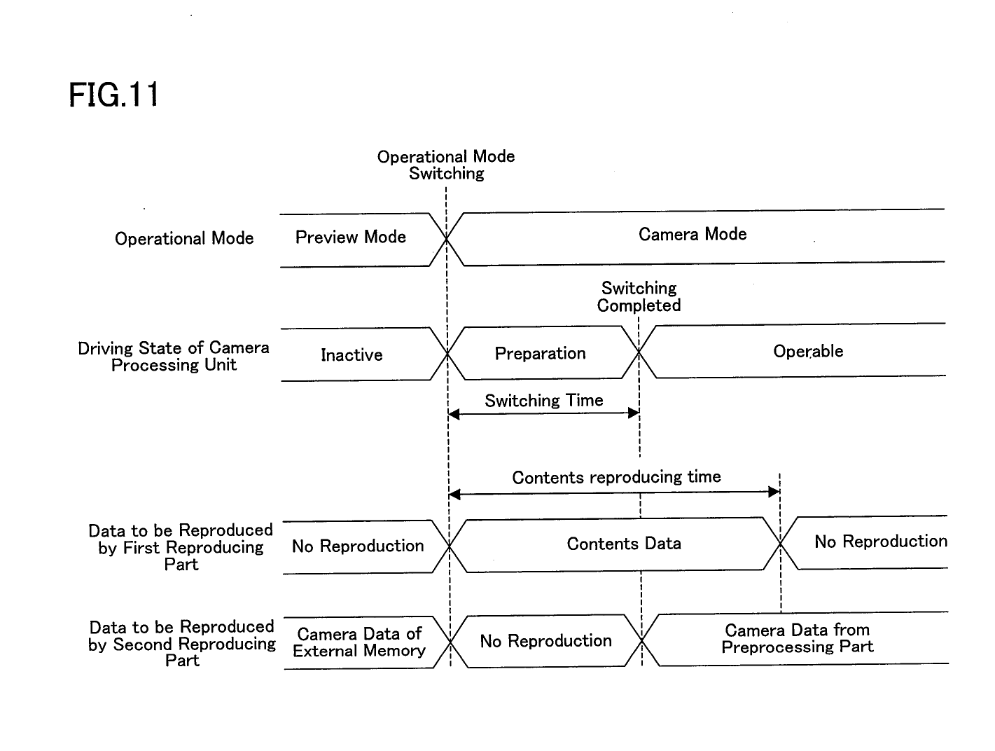

Alternatively, the reproducing part 103 may include a first reproducing part 103a for reproducing the contents data Dc and a second reproducing part 103b for reproducing digital image data Dd and Dm as shown in FIG. 9. When this configuration is employed, even in the case where the contents data Dc and the digital image data Dd and Dm are different in the data format, the contents data Dc and the digital image data Dd and Dm can be respectively reproduced. As the operation (such as the operation for switching the “preview mode” to the “camera mode”) of a digital signal processing circuit of FIG. 9, any of the following two operations (respectively shown in FIGS. 10 and 11) may be employed:

(1) As shown in FIG. 10, when the controlling part 105 detects the operational mode switching, it allows the second reproducing part 103b to suspend the reproduction of digital image data Dm supplied from the external memory 2. Also, the controlling part 105 controls the external memory controlling part 102 so as to supply contents data Dc to the first reproducing part 103a, and allows the first reproducing part 103a to reproduce the contents data Dc. Next, after a contents reproducing time Tc has elapsed, the controlling part 105 allows the first reproducing part 103a to suspend the reproduction of the contents data Dc, and thereafter, allows the second reproducing part 103b to reproduce digital image data Dd supplied by the preprocessing part 101.

In this manner, the contents data Dc is reproduced by the first reproducing part 103b until the contents reproducing time Tc elapses, and the digital image data Dd supplied by the preprocessing part 101 is reproduced by the second reproducing part 103b after the contents reproducing time Tc has elapsed.

(2) As shown in FIG. 11, when the controlling part 105 detects the operational mode switching, it allows the second reproducing part 103b to suspend the reproduction of digital image data Dm supplied by the external memory 2. Also, the controlling part 105 controls the external memory controlling part 102 so as to supply contents data Dc to the first reproducing part 103a, and allows the first reproducing part 103a to reproduce the contents data Dc. Next, when the operational mode switching is completed, the controlling part 105 allows the second reproducing part 103b to reproduce digital image data Dd supplied by the preprocessing part 101. On the other hand, when a contents reproducing time Tc has elapsed, the controlling part 105 allows the first reproducing part 103a to suspend the reproduction of the contents data Dc.

In this manner, the contents data Dc is reproduced by the first reproducing part 103a before the contents reproducing time Tc elapses, and the digital image data Dd supplied by the preprocessing part 101 is reproduced by the second reproducing part 103b even before the contents reproducing time Tc elapses as far as the operational mode switching is completed.

### [Place for Storing Contents Data]

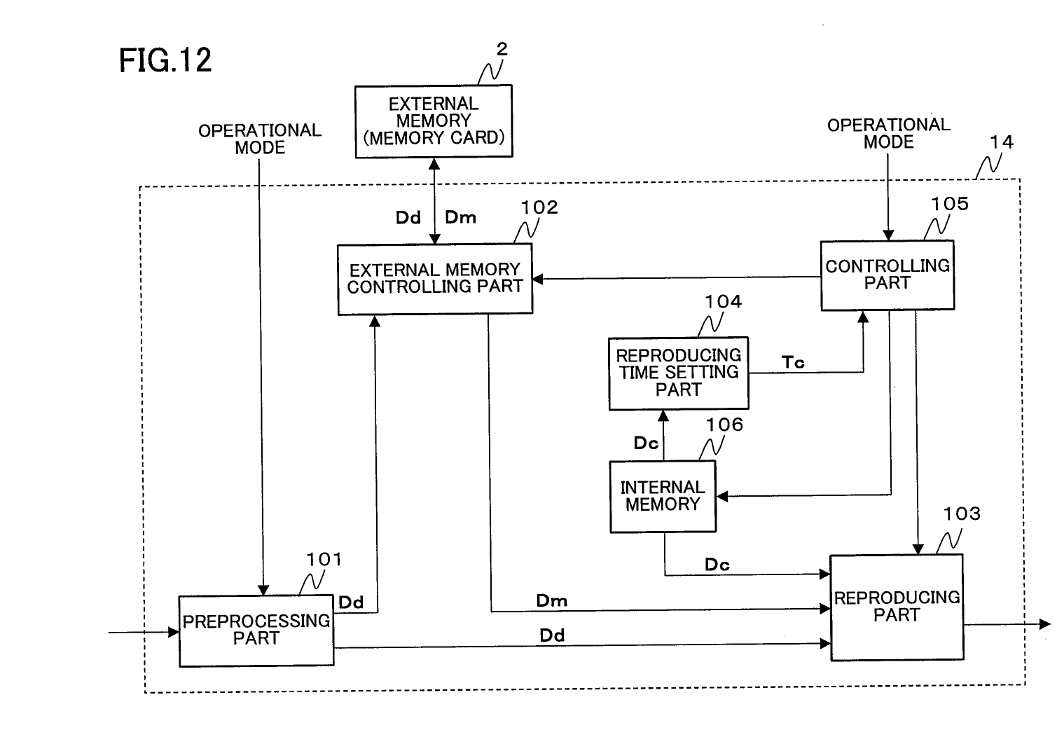

Alternatively, as shown in FIG. 12, the digital signal processing circuit may further include an internal memory 106. The internal memory 106 stores contents data Dc. In this case, the controlling part 105 controls the internal memory 106 so as to supply the contents data Dc to the reproducing time setting part 104 for allowing the reproducing time setting part 104 to set a contents reproducing time Tc. Also, when the controlling part 105 detects operational mode switching, it controls the internal memory 106 so as to supply the contents data Dc to the reproducing part 103 for allowing the reproducing part 103 to reproduce the contents data Dc. In this manner, the contents data Dc may be stored in the internal memory 106 provided within the digital signal processing circuit 14 instead of the external memory 2.

### [Alternative Architectures]

Alternatively, the camera device 1 may further include, in addition to the components shown in FIG. 1, other circuits related to the image processing (such as a color temperature measuring circuit, a sensor flaw measuring circuit, a focusing level measuring circuit, a subject brightness measuring circuit and a sensor dust removing circuit). In this case, the timing for entering an “operable state” (namely, the timing for completing the operational mode switching) may be set as a time when the preparation of the imaging circuit 11, the analog signal processing circuit 12 and the A/D conversion circuit 13 is completed as in the aforementioned embodiments or a time when the preparation of the imaging circuit 11, the analog signal processing circuit 12 and the A/D conversion circuit 13 as well as the processing of these other circuits is completed.

Although the data processing circuit is used in the camera device in each of the embodiments, the application is not limited to the camera device but the data processing circuit of each embodiment is applicable to any device in which a plurality of operational modes are selectively switched. In other words, the data reproduced by the reproducing part 103 is not limited to the digital image data (static image data) but may be dynamic image data, speech data (music data or sound data), text data or the like.

According to the present invention, contents data can be appropriately reproduced in the operational mode switching, and therefore, the invention is useful for a device, such as a camera device, in which a plurality of operational modes are selectively switched.

What is claimed is:

1. A data processing circuit capable of switching selectively among a plurality of operational modes, comprising:
a storing part for storing contents data to be reproduced in operational mode switching;
a reproducing part for reproducing data to be reproduced in each of the plurality of operational modes and reproducing the contents data stored in the storing part; and
a controlling part for allowing, in detecting the operational mode switching, the reproducing part to reproduce the contents data until a contents reproducing time necessary for reproducing the contents data elapses and allowing the reproducing part to reproduce given data to be reproduced in a switched operational mode after the contents reproducing time elapses.

2. The data processing circuit of claim 1,
wherein the contents reproducing time is longer than a time necessary for completing the operational mode switching.

3. The data processing circuit of claim 1,
wherein the controlling part elongates the contents reproducing time when the contents reproducing time is shorter than the time necessary for completing the operational mode switching.

4. The data processing circuit of claim 1,
wherein when the controlling part externally receives a reproducing instruction after completing the operational mode switching, the controlling part allows the reproducing part to suspend reproduction of the contents data and to reproduce the given data even before the contents reproducing time elapses.

5. The data processing circuit of claim 1, further comprising a setting part for setting the contents reproducing time on the basis of a data size of the contents data stored in the storing part.

6. The data processing circuit of claim 5,
wherein the data size is one of a file size, a code size, a code size to be reproduced per unit time and a view angle size of the contents data.

7. The data processing circuit of claim 1, further comprising a setting part for setting the contents reproducing time on the basis of complexity of the contents data stored in the storing part.

8. The data processing circuit of claim 1, further comprising a setting part for setting the contents reproducing time on the basis of a residue of a power source for supplying power to the data processing circuit.

9. The data processing circuit of claim 1, further comprising a setting part for setting the contents reproducing time on the basis of a reproducing time included in a header of the contents data.

10. The data processing circuit of claim 1,
wherein the storing part stores a plurality of contents data, and
the controlling part allows the reproducing part to reproduce one of the plurality of contents data stored in the storing part until the contents reproducing time elapses.

11. The data processing circuit of claim 10, further comprising a setting part for calculating reproducing times respectively necessary for reproducing the plurality of contents data stored in the storing part and setting a longest reproducing time among the calculated reproducing times as the contents reproducing time.

12. The data processing circuit of claim 10, further comprising a setting part for calculating reproducing times respectively necessary for reproducing the plurality of contents data stored in the storing part and setting a shortest reproducing time among the calculated reproducing times as the contents reproducing time.

13. The data processing circuit of claim 10, further comprising a setting part for calculating reproducing times respectively necessary for reproducing the plurality of contents data stored in the storing part, executing weighted addition of the calculated reproducing times and setting a result of the weighted addition as the contents reproducing time.

14. The data processing circuit of claim 1, further comprising:
a comparing part for obtaining similarity between template data set on the basis of a user's taste and the contents data stored in the storing part; and
a setting part for setting the contents reproducing time on the basis of the similarity obtained by the comparing part.

15. The data processing circuit of claim 1,
wherein the contents reproducing time is externally settable.

16. The data processing circuit of claim 1,
wherein the reproducing part includes a first reproducing part for reproducing the contents data and a second reproducing part for reproducing the given data, and
the controlling part allows the first reproducing part to reproduce the contents data until the contents reproducing time elapses and allows the second reproducing part to reproduce the given data after the contents reproducing time elapses.

17. The data processing circuit of claim 1,
wherein the reproducing part includes a first reproducing part for reproducing the contents data and a second reproducing part for reproducing the given data, and
the controlling part allows the first reproducing part to reproduce the contents data until the contents reproducing time elapses and allows the second reproducing part to reproduce the given data when the operational mode switching is completed even before the contents reproducing time elapses.

18. The data processing circuit of claim 1,
wherein the contents data is one of image data, speech data and text data.

19. The data processing circuit of claim 1,
wherein the storing part is an external memory removable from the data processing circuit.

20. The data processing circuit of claim 1,
wherein the storing part is an internal memory included in the data processing circuit.

21. A semiconductor device capable of switching selectively among a plurality of operational modes, comprising:
a storing part for storing contents data to be reproduced in operational mode switching;
a reproducing part for reproducing data to be reproduced in each of the plurality of operational modes and reproducing the contents data stored in the storing part; and
a controlling part for allowing, in detecting the operational mode switching, the reproducing part to reproduce the contents data until a contents reproducing time necessary for reproducing the contents data elapses and allowing the reproducing part to reproduce given data to be reproduced in a switched operational mode after the contents reproducing time elapses.

22. A camera device capable of switching selectively among a plurality of operational modes including a camera mode, comprising:
an image processing unit for converting an image of a subject into an electric signal and generating image data on the basis of the electric signal in the camera mode;
a storing part for storing contents data to be reproduced in switching to the camera mode; and
a data processing part for reproducing, in detecting the switching to the camera mode, the contents data until a contents reproducing time necessary for reproducing the contents data elapses and for reproducing image data obtained by the image processing unit after the contents reproducing time elapses.

23. A method for controlling a data processor having a plurality of operational modes, comprising the steps of:
(a) switching an operational mode of the data processor;
(b) allowing the data processor to reproduce previously determined contents data after switching the operational mode in the step (a) and to continuously reproduce the contents data until a contents reproducing time necessary for reproducing the contents data elapses; and
(c) allowing the data processor to reproduce data to be reproduced in the switched operational mode after the contents reproducing time elapses.
